(19) United States
(12) Patent Application Publication
(10) Pub. No.: US 2026/0181420 A1
(43) Pub. Date: Jun. 25, 2026

(54) IN-NETWORK AI/ML MODEL DISCOVERY AND USE PROTOCOL

(71) Applicant: Advanced Micro Devices, Inc., Santa Clara, CA (US)

(72) Inventor: Jose Manuel MONSALVE DIAZ, Santa Clara, CA (US)

(21) Appl. No.: 19/000,190

(22) Filed: Dec. 23, 2024

(51) Int. Cl. H04W 24/02; H04W 12/06; H04W 12/084; H04W 80/02

(52) U.S. Cl. CPC H04W 24/02; H04W 12/06; H04W 12/084; H04W 80/02

(57) ABSTRACT

Embodiments herein describe an artificial intelligence/machine learning (AI/ML) endpoint including circuitry to communicate with a user endpoint by broadcasting a beacon, receiving an AI/ML model request from the user endpoint, performing a model compute operation to select an AI/ML model, and transmitting the AI/ML model to the user endpoint. The AI/ML endpoint creates a low level communication protocol to communicate with the user endpoint, the low level communication protocol included in Layer 2 of the open systems interconnection (OSI) model. The user endpoint receives the AI/ML model from the AI/ML endpoint without having prior information about the AI/ML endpoint.

### TECHNICAL FIELD

Examples of the present disclosure generally relate to networks, and, in particular, to broadcasting artificial intelligence/machine learning (AI/ML) models, its weights, inputs, or outputs to nearby devices.

### BACKGROUND

Artificial Intelligence (AI) and Machine Learning (ML) models are advanced computational systems that enable machines to learn from data, identify patterns, and make predictions or decisions without explicit programming. AI/ML models are trained on large datasets, using algorithms such as neural networks, decision trees, or support vector machines to uncover relationships within the data. Depending on the type of learning, AI/ML models can perform a variety of tasks. The ability of these models to improve over time by learning from new data is a fundamental feature that distinguishes AI/ML systems from traditional programming. AI/ML technologies are continually evolving, driven by advances in algorithms, computational power, and access to large, diverse datasets. AI/ML models have become foundational to innovations in automation, data-driven decision-making, and intelligent systems, transforming the way businesses and technologies operate.

### SUMMARY

One embodiment described herein is an artificial intelligence/machine learning (AI/ML) endpoint including circuitry to communicate with a user endpoint by broadcasting a beacon, receiving an AI/ML model request from the user endpoint, performing a model compute operation to select an AI/ML model, and transmitting the AI/ML model to the user endpoint. The AI/ML endpoint creates a low level communication protocol to communicate with the user endpoint, the low level communication protocol included in Layer 2 of the open systems interconnection (OSI) model. The user endpoint receives the AI/ML model from the AI/ML endpoint without having prior information about the AI/ML endpoint. The compute operation includes retrieving the AI/ML model from a database including pre-generated AI/ML models or generating the AI/ML model based on information submitted in the AI/ML model request from the user endpoint.

One embodiment described herein is a method including broadcasting a beacon from an artificial intelligence/machine learning (AI/ML) endpoint, sending, by a user endpoint, an AI/ML model request to the AI/ML endpoint upon detection of the beacon, performing, by the AI/ML endpoint, a model compute operation to select an AI/ML model, and transmitting the AI/ML model to the user endpoint.

One embodiment described herein is an artificial intelligence/machine learning (AI/ML) endpoint including circuitry to receive an AI/ML model request from a user endpoint sending a beacon broadcast, the AI/ML endpoint requesting authentication from the user endpoint, receiving authentication information from the user endpoint, sending an authentication token to the user endpoint, receiving a resubmission of the AI/ML model request and the authentication token from the user endpoint, performing a model compute operation to select the AI/ML model, and transmitting the AI/ML model to the user endpoint.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a network for broadcasting artificial intelligence/machine learning (AI/ML) models, its weights, inputs, or outputs to nearby devices, according to an example.

FIG. 2 illustrates communications between user endpoints and AI/ML model endpoints, according to an example.

FIG. 3 illustrates a method for transmitting an AI/ML model from an AI/ML endpoint to a user endpoint without authentication, according to an example.

FIG. 4 illustrates a method for transmitting an AI/ML model from an AI/ML endpoint to a user endpoint with authentication, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

In wireless communication systems, such as those adhering to the IEEE 802.11 standard (commonly known as Wi-Fi), a collection of frames is used to enable various network functions, including the discovery and connection to wireless networks. These frames operate at the data link layer (Layer 2) of the open systems interconnection (OSI) model and are used for communication between wireless devices (stations) and access points (APs) in a Wi-Fi network. Wireless networks rely on a discovery mechanism to enable client devices (such as, e.g., laptops, smartphones, and Internet-of-things (IoT) devices) to find nearby Wi-Fi networks. This discovery process is accomplished using management frames, which are exchanged between APs and client devices before a connection is established. The exchange of management frames, such as beacon frames and probe frames, is beneficial for enabling devices to seamlessly discover and connect to available Wi-Fi networks.

In a Wi-Fi network that uses the 802.11 standard, different types of management frames are employed to facilitate network discovery, connectivity, and maintenance. These management frames identify available networks, establishing connections, and maintaining the link between devices. In one example, a beacon frame may be used. The beacon frame is used by an access point (AP) to announce the presence of a wireless network. The beacon frame is periodically broadcasted, usually every 100 milliseconds, to allow nearby devices to detect and learn about the network. The beacon frame may include, e.g., a service set identifier (SSID), supported data rates, a channel number, security information, and a timestamp. The SSID is the network name that enables devices to recognize the network. SSIDs are broadcast by wireless APs to enable devices to discover and connect to the network. The process of broadcasting SSIDs happens through beacon frames within the 802.11 Wi-Fi standard.

In operation, in passive scanning, devices like smartphones or laptops listen for beacon frames to discover available networks. The SSID included in the beacon frame enables the device to show a list of networks to the user. In active scanning, devices can send probe requests to search for networks by broadcasting a frame asking for networks. APs respond with probe responses including the SSID and other details. In such case, authentication frames and association request frames may be used. Authentication frames are used during the authentication process when a client device is trying to connect to a network. Authentication frames initiate the process of verifying a device before it can associate with an AP. Regarding association request frames, once a device has successfully authenticated, it sends an association request frame to the AP to request to join the network. Association request frames may include detailed information about the capabilities of the client device.

In current network environments and architectures, it is useful to access and use AI/ML models. AI/ML models are computational systems that use algorithms and data to perform tasks that involve human intelligence. These tasks may involve recognizing patterns, making predictions, and classifying data. AI models simulate human intelligence and can be rule-based or ML-based. ML models are a subset of AI where systems learn patterns from data and improve over time without explicit programming. ML models can be trained on historical data to make predictions or decisions based on new inputs.

In current systems, accessing AI/ML models may be accomplished by having access to a user's local device or by having access to a server/client architecture. In the local device access method, the data is processed on the device itself without the need for cloud connectivity. However, running complex AI/ML models on local devices can be constrained by hardware capabilities and large AI/ML models may be difficult to run locally due to limited memory and storage on such devices. Additionally, this is limiting as the AI/ML model needs to have been previously shared with the local device. In the server/client architecture access method, the AI/ML model is hosted on a server (e.g., on the cloud) and the user device acts as the client that sends data to the server for inference. However, running complex AI/ML models on servers can be challenging due to latency issues, data privacy issues, and dependency on Internet connectivity. Sending data to a remote server and waiting for a response can introduce delays. Further sensitive data may be transmitted to the server, raising data security and privacy concerns. Also, running complex AI/ML models on servers involves using a full application stack. Current systems do not allow for devices that are in proximity to networks to communicate and provide AI/ML models to other systems without having to first establish a connection, that is, without using the fully-layered network protocol structure as defined by the OSI model.

The example embodiments present a method and system for broadcasting different AI/ML models, its weights, inputs, or outputs to client devices or user endpoints. The examples establish a mechanism to expose and use AI/ML models from nearby devices (e.g., AI/ML endpoints). The example system creates a low level (Layer-2) communication protocol that can be used to expose, optionally authenticate, and use an AI/ML model that is observed in a physical media (e.g., over wireless networks or wired Ethernet-like networks). This is similar to how a Wi-Fi network can be exposed via IEEE 802.11. As such, a client device (e.g., a user endpoint) can establish a connection without having prior information about the existence of an AI/ML endpoint. The user endpoint may request the AI/ML model and receive the AI/Ml model without making a direct connection to the AI/ML endpoint, that is, without using the fully-layered network protocol structure as defined by the OSI model. Thus, all the layers of the OSI model need not be used. Instead, only Layer 2 of the OSI model may be used to complete the transfer of the AI/ML model from the AI/ML model endpoint to the user endpoint.

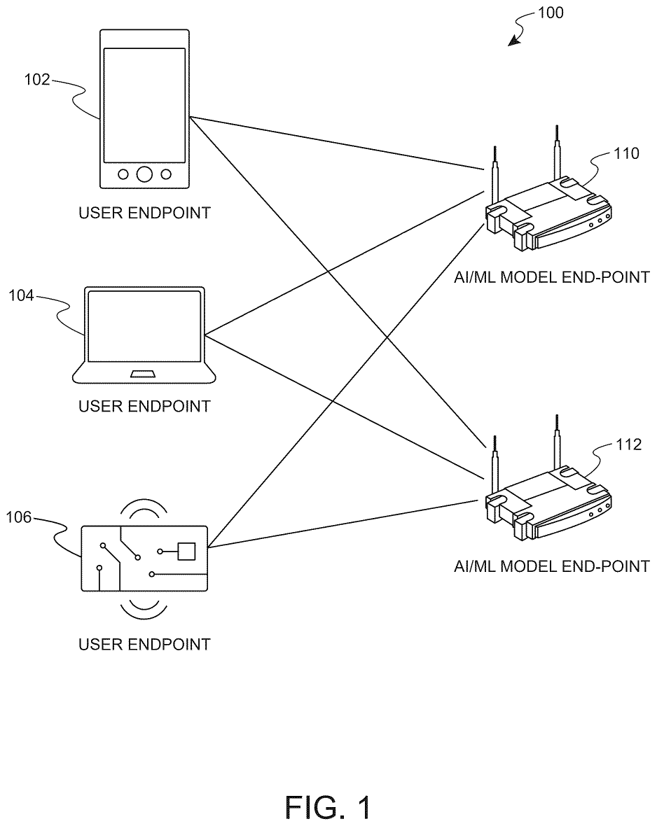

FIG. 1 illustrates a network for broadcasting artificial intelligence/machine learning (AI/ML) models, its weights, inputs, or outputs to nearby devices, according to an example.

The network 100 includes a plurality of user endpoints. The user endpoints can also be referred to as client devices. In one example, the network 100 shows a first user endpoint 102, a second user endpoint 104, and a third user endpoint 106. The network 100 may include more or less user endpoints. The plurality of user endpoints are devices that send and receive data within the network 100. The plurality of user endpoints may include, but are not limited to, smartphones, laptops, tablets, desktops, wearables, printers, scanners, and Internet-of-thing (IoT) devices. IoT devices may include, e.g., smart home hubs, security cameras, smart speakers, and smart thermostats.

The plurality of user endpoints can communicate with a plurality of AI/ML endpoints or AI/ML model endpoints. In one example, the network 100 depicts an AI/ML endpoint 110 and an AI/ML endpoint 112. The network 100 may include more or less AI/ML endpoints. The plurality of AI/ML model endpoints host, deploy or use AI/ML models. The plurality of AI/ML model endpoints provide access to AI/ML capabilities, enabling devices or applications on the network 100 to interact with the AI/ML models for tasks such as, e.g., inference, analysis, and decision-making.

The purpose of a user endpoint is to search for nearby broadcast messages, broadcast an AI/ML model request to nearby devices, submit model compute requests and submit the input parameters, and provide authentication information if necessary. In particular, the user endpoint may continuously scan its environment for broadcast messages from nearby devices or systems (e.g., AI/ML endpoints). These broadcast messages may include information about available AI/ML models, computational resources, or status updates. The scanning allows the user endpoint to discover and connect to relevant services or resources dynamically within its immediate vicinity.

The user endpoint has the ability to broadcast requests or queries or inquiries for AI/ML models to nearby devices or systems (e.g., AI/ML endpoints). This functionality is useful when the user needs to access a particular AI/ML model (or set of AI/ML models) that may be locally available. By broadcasting a request or inquiry, the user endpoint seeks model providers (e.g., AI/ML endpoints) that are capable of fulfilling the request or inquiry, ensuring efficient resource sharing and AI/ML model discovery.

To process an AI/ML model request, the AI/ML endpoint enables user endpoints to submit input parameters. These input parameters are tailored to the specific AI/ML model and task at hand, ensuring that the AI/ML model can perform its intended function correctly. Parameters could include data sets, real-time sensor data, or contextual information that influences the model's inference or learning process.

In other embodiments, the AI/ML models can forward a total or partial set of weights, prompts, or any other parameter to the user endpoint.

To ensure secure and authorized access to AI/ML models and computational resources, the user endpoint supports authentication mechanisms. This includes submitting credentials, tokens, or other forms of authentication that verify the identity of the user or the device. By providing this information, the AI/ML endpoint ensures that only authenticated users can access sensitive models or offload tasks to trusted devices, enhancing security and privacy.

The plurality of AI/ML model endpoints host and serve one or more AI/ML models that can receive input data, process the data through the AI/ML model, and return predictions or classifications. The AI/ML model may be, e.g., a deep learning (DL) model, a machine learning (ML) classifier, or a natural language processing (NLP) model. The plurality of AI/ML model endpoints may provide real-time or near real-time inference, meaning they can take input data and quickly return results. The plurality of AI/ML model endpoints may perform additional data preprocessing or feature extraction before sending the input data through the AI/ML model. This can include normalizing data, removing noise, or converting raw data into a format suitable for the AI/ML model. The plurality of AI/ML model endpoints can communicate with other network endpoints such as IoT devices, smartphones, or edge devices, taking in data from these devices and sending back predictions or commands to the user endpoints.

The plurality of AI/ML model endpoints may be cloud-based AI/ML model endpoints or edge AI/ML model endpoints or on-premises AI/ML model endpoints. The plurality of AI/ML model endpoints may also act as a gateway to other models available in cloud-based AI/ML model endpoints or edge AI/ML model endpoints or on-premises AI/ML model endpoints. In this form, the plurality of AI/ML model endpoints will bridge local messages, and forward them with or without modifications to other endpoints. The AI/ML models may include, but are not limited to, large language models (LLMs), generative models, convolutional neural networks (CNNs), recurrent neural networks (RNNs), long short-term memory (LSTM) networks, reinforcement learning (RL) models, and clustering algorithms.

The purpose of an AI/ML model endpoint is to broadcast its presence, respond to requests for a specific AI/ML model type, respond to an AI/ML model use request by computing (either locally or remotely) via the model parameters, and authenticate a user endpoint if necessary. In particular, the AI/ML endpoint continuously sends out broadcast signals to announce its availability and the AI/ML models it can support and provide. These broadcasts make nearby devices aware of the AI/ML endpoint's capabilities, including the types of AI/ML models it hosts (e.g., classification models, reinforcement learning agents) and any available computational power. This proactive broadcasting enables other devices in the vicinity, such as user endpoints or client devices, to discover the AI/ML models without manual intervention.

When a nearby user endpoint sends out a request for a particular type of AI/ML model, the AI/ML endpoint evaluates whether it has the requested AI/ML model. If the AI/ML endpoint hosts the requested AI/ML model, the AI/ML endpoint sends an appropriate response back to the requesting user endpoint, confirming the availability of the AI/ML model and its readiness to compute. This interaction ensures that user endpoints only interact with AI/ML endpoints that can meet their AI/ML model requirements, thus streamlining resource allocation.

Upon receiving a valid AI/ML model use request, the AI/ML endpoint processes the incoming input parameters and runs the AI/ML model computations as requested. The AI/ML endpoint performs the necessary inference or training tasks using the input data provided by the user endpoint. Once the computation is complete, the AI/ML endpoint returns the results (e.g., predictions, classifications, or optimizations) to the requesting user endpoint.

In one example, the AI/ML endpoint includes mechanisms to authenticate users or devices or user endpoints before granting access to its AI/ML models. This authentication process may involve verifying user credentials, tokens, or other security protocols to ensure that only authorized user endpoints can access sensitive models or perform computations. This is beneficial in maintaining the security and integrity of the AI/ML system, especially in networks where multiple user endpoints are interacting with one or more AI/ML endpoints. Authentication mechanisms prevent unauthorized access and ensure compliance with privacy and security standards.

The benefits of using the plurality of AI/ML model endpoints include at least reduced latency, scalability, privacy and security, customization, and intelligence at the edge. By placing AI/ML models closer to where data is generated (e.g., at the edge or on-premises), the time it takes for data to be processed and for decisions to be made is reduced. Cloud-based AI/ML endpoints provide elastic resources, allowing models to scale as demand increases. This makes cloud-based AI/ML endpoints ideal for applications with fluctuating workloads. On-premises and edge AI endpoints offer better control over sensitive data, as information can be processed locally without being sent to the cloud. AI/ML endpoints can enable deployment of custom models tailored to specific applications. This can include AI/ML models trained on proprietary data or tuned for unique use cases. In edge computing, AI/ML endpoints bring processing power closer to the devices generating the data, enabling low-latency decision-making and offline capabilities in environments with intermittent connectivity.

Further benefits of using the plurality of AI/ML model endpoints include faster AI/ML model updates, dynamic AI/ML model sharing, and no network infrastructure needed. Devices can continuously update and improve their AI/ML models by opportunistically receiving new knowledge from nearby devices, improving overall system intelligence without human intervention. Devices that interact intermittently (e.g., in mobile or IoT environments) can learn from each other as they come into proximity, without setting up a network connection, that is, without using the fully-layered network protocol structure as defined by the OSI model.

When it is said that the user endpoint does not make a direct connection with the AI/ML endpoint to receive AI/ML models, it means that the communication does not follow a conventional, fully-layered network protocol structure (like those defined by the OSI model, which spans from Layer 1 to Layer 7). Specifically, the system and method may only use Layer 2 (the Data Link Layer) of the OSI model, without involving higher layers such as Layer 3 (network layer), Layer 4 (transport layer), or beyond. This setup allows communication to occur locally within the same network segment and is optimized for specific scenarios, avoiding the complexity and overhead of higher-layer protocols like IP routing (Layer 3), session management (Layer 5), or application-specific protocols (Layer 7). Usually, in a full OSI layer implementation, data passes through all seven layers (from physical connectivity to application protocols). By using Layer 2 only, the system and method avoids routing (Layer 3), transport protocols like TCP/UDP (Layer 4), and application-level protocols (Layer 7) such as hypertext transfer protocol (HTTP) or representative state transfer application programming interfaces (REST APIs). Instead, the data link layer handles the framing, error control, and medium access control, reducing communication complexity and overhead.

Further, the AI/ML endpoints can communicate AI/ML models without a central server or Internet connection, making this ideal for remote or disconnected environments. Since no formal connections are involved, the broadcast mechanism significantly reduces the time and energy needed to exchange data. This is especially beneficial for low-power IoT devices or devices that are constantly on the move (e.g., drones, vehicles). By only broadcasting necessary information (e.g., model parameters or updates), devices can optimize their battery usage and bandwidth, allowing for efficient exchanges without draining resources.

Further benefits of using the plurality of AI/ML model endpoints include that the AI/ML model predictions may be more accurate and contextually appropriate since they are based on the nuances of the local area. AI/ML models can adjust to the dynamic needs of the local environment. Another benefit is the ability to access AI/ML models with local context that achieves higher precision in AI decision-making. Because the AI/ML models are associated with a local network or physical infrastructure (e.g., Wi-Fi hotspots, IoT networks), they can be accessed more quickly by nearby client devices or user endpoints without the need for constant connectivity to the cloud. Reduced reliance on the cloud means that decisions can be made at the edge, closer to where the data is being generated. This results in faster processing times and lower bandwidth requirements. Additionally, the AI/ML model endpoints may use the plurality of user endpoint devices to make global decisions that use aggregated trends from data and requests received via this protocol, or via additional data sources connected to the network (e.g., sensors, and cameras). In such cases, the responses to the user endpoints can be tailored to the changing environmental conditions.

In one example, the systems and methods provide for a low level (Layer 2) network protocol for the discovery of AI/ML models that are in the nearby devices (e.g., AI/ML endpoints). This is similar in nature to how SSIDs are broadcasted, and devices can connect to them. However, instead of broadcasting SSIDs, the examples broadcast AI/ML models, its weights, inputs, or outputs that are available nearby. In one example, a user endpoint can issue a request for use of the AI/ML model, and provide a connectionless use of the AI/ML model, without the need for a full layer implementation. This enables access to AI/ML models that are specific to the environment. For example, a user operating the first user endpoint 102 may be at a venue. The user can operate the first user endpoint 102 to automatically access, e.g., an LLM-like model that has been trained to provide details about the venue. In another example, the user endpoint can make a query or inquiry for the use of a specific AI/ML model. The AI/ML endpoint may generate a list of AI/ML models for the user endpoint to select from. Once again, a connectionless use of the AI/ML model is provided, without the need for a full layer implementation.

The connections between the plurality of user endpoints and the plurality of AI/ML model endpoints may be wired connections or wireless connections.

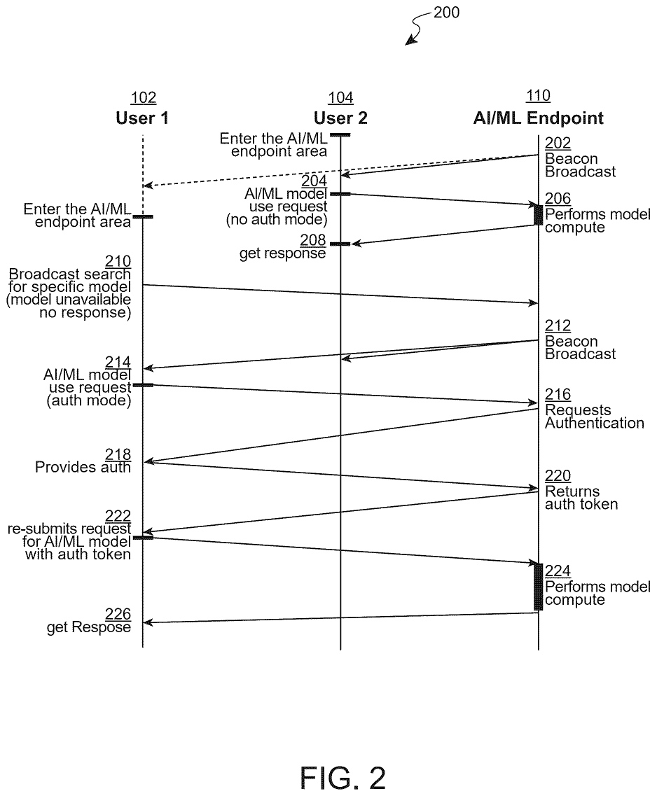

FIG. 2 illustrates communications between user endpoints and AI/ML model endpoints, according to an example.

In a Wi-Fi network that uses IEEE 802.11, a collection of frames are used for discovery of nearby Wi-Fi networks. For example, a beacon management frame is used to periodically send information regarding the presence of a network with a given SSID (i.e., Wi-Fi name). Likewise, whenever a device wants to establish a connection with the network, there is an association request frame and other authentication frames that are used. In the examples, similar mechanisms are established. However, instead of exposing a client device or user endpoint to nearby networks, the examples expose different AI/ML models to nearby client devices or user endpoints. Any type of AI/ML models can be shared, such as, supervised learning models (e.g., classification algorithms), unsupervised learning models (clustering algorithms), RL models (Q-learning), and DL models (CNN models, RNN models, etc.). Agreements can be established beforehand to the different kinds of AI/ML models to be shared.

A communication protocol is established between the user endpoints and the AI/ML model endpoints, which uses the lower level physical network to transmit different messages for requests. Using the lower level physical network refers to how communication occurs at the lower layers of the network stack (e.g., Layer 2 of the OSI model) to carry out specific types of network communication. The OSI model defines seven layers of communication, ranging from the physical layer (Layer 1) to the application layer (Layer 7). Layer 2 is the data link layer, which is responsible for data framing, media access control (MAC) addresses, and ensuring that data is error-free as the data moves from one device to another device directly connected to the same network (e.g., Ethernet, Wi-Fi). The data link layer (Layer 2) carries out operations such as requests for data, service requests, and discovery of networks. For example, in a Wi-Fi network, when a device (e.g., a smartphone) is searching for a Wi-Fi network, the device uses the lower-level physical network (e.g., Layer 2) to send probe request frames. These frames are broadcasted to discover nearby Wi-Fi networks, which in turn respond with beacon frames that provide network details, such as the SSID. Similar to this methodology, instead of broadcasting SSIDs, the present system and method broadcasts AI/ML models.

Benefits of using only Layer 2 of the OSI model (instead of all seven layers of the OSI model) include that Layer 2 protocols manage the direct, efficient transfer of data between devices on a local network, minimizing overhead. Because Layer 2 operates at the data link layer, it ensures low latency and fast frame delivery within a local area. Many Layer 2 protocols include mechanisms for detecting and correcting errors that may occur during data transmission. As such, the present approach expands the use of low level network protocols by providing intelligence to systems and by offloading computations across elements.

Moreover, different type of data frames may be used for enabling communications between the user endpoints and the AI/ML endpoints. Such data frames may include beacon data frames, request data frames, response data frames, and authentication request data frames.

The beacon data frame informs nearby devices (i.e., those reachable by the physical media) that an AI/ML endpoint is available. There may be two types of beacon messages. Generic beacon messages that inform of the availability of an AI/ML endpoint, or a specific beacon that informs nearby devices of the presence of an AI/ML data frame that supports a set of types/models. The former is intended to provide flexibility and reduce traffic. The beacon data frame is a multi-cast data frame and is not directed to any particular user. In one example, the beacon frame may include AI/ML model type, the purpose of the AI/ML model, a size of the AI/ML model, training information, AI/ML model performance, and AI/ML model capabilities.

In another embodiment, the user endpoint may initiate the communication by having a beacon request packet. In this user initiated communication, information about specific models may be requested, and only those AI/ML endpoints that have access to those models may respond.

The request data frame is used for a user to request the use of a specific AI/ML model. The request data frame is directed to a specific AI/ML endpoint. There are two modes of the request data frame, that is, anonymous or authenticated requests. Both modes enable a user to request a computation for a given AI/ML model or model types. However, some AI/ML models may need authentication. This may include using authentication frames. These frames are used during the authentication process when a client device is trying to connect to a network. Authentication frames initiate the process of verifying a device before it can associate with an access point (AP).

After authentication has been performed, an authentication token can be used to sign the requests. A single AI/ML model may support authenticated or anonymous methods. For example, an LLM model may provide generic responses to anonymous requests, but add sensitive information only on authenticated ones. The request data frame may need to be split into multiple packets depending on the implementation and the limitations of the underlying physical network protocols. This is implementation specific, but such implementation decide if error detection/correction is necessary or any other features that may improve system usability and stability.

The response data frame includes the response after the AI/ML model has been used for computation. The content of the response data frame is then interpreted by the application or system behind the user endpoint.

The authentication request data frame is necessary for establishing authentication and authorization mechanisms for certain models. Different methods can be used, between synchronous and asynchronous communications.

Referring back to FIG. 2, an example communication flow is presented. In the example, there are two user endpoints and one AI/ML endpoint. The AI/ML endpoint 110 uses beacon messages to the physical network to inform of its presence. The first user endpoint 102 and the second user endpoint 104 are dynamically added or removed from the area of effect (or local area) of the AI/ML endpoints. A user may decide to send a request data frame at any point. This data frame includes an AI/ML type and the input parameters. For anonymous requests, if supported by the AI/ML model and the AI/ML endpoint, a response data frame is sent right after computation is completed. For authenticated requests, the AI/ML endpoint 110 checks for authentication. If not authenticated, the AI/ML endpoint 110 sends an authentication request data frame to the user that tried to use the AI/ML model. An authentication handshake is performed, and the result can be used to allow for the user to re-submit the request to the AI/ML endpoint 110.

In one example, in passive scanning, when the second user endpoint 104 enters the AI/ML endpoint area, the AI/ML endpoint 110 sends a beacon request 202 to the second user endpoint 104. The AI/ML endpoint 110 sends the beacon request 202 to inform the second user endpoint 104 of its presence. In passive scanning, the AI/ML endpoint 110 initiates communication by making its presence known to a user endpoint that is within its vicinity. The AI/ML endpoint 110 can inform the user endpoint in the vicinity of the AI/ML models the AI/ML endpoint 110 can support and provide.

The second user endpoint 104 may decide to send an AI/ML model use request 204. The AI/ML endpoint 110 receives the AI/ML model use request 204 and performs a model compute operation 206. After the model compute operation 206 is performed, the AI/ML endpoint 110 sends the AI/ML model 208 to the second user endpoint 104. In other words, for the model compute, the AI/ML endpoint executes the underlying computations needed for the AI/ML model to produce a result or make an inference.

Using only Layer 2 of the OSI model to establish a connection between a user endpoint and an AI/ML endpoint has several benefits, particularly when it comes to simplicity, performance, and security. Layer 2 (the Data Link Layer) is responsible for node-to-node data transfer over a physical network, often dealing with media access control (MAC) addresses, frames, and local network protocols like Ethernet. By limiting communication to Layer 2, advantages can be achieved tailored to low-latency and localized network setups. Layer 2 connections occur within a local network segment, usually over Ethernet or Wi-Fi, which avoids the overhead of higher layers like Layer 3 (IP routing) and Layer 4 (TCP/UDP). This direct communication minimizes delays, providing faster interaction with the AI/ML models. Higher layers such as Layer 3 (IP) or Layer 4 (TCP/UDP) introduce additional protocol headers and processing complexity.

By using only Layer 2, the communication is streamlined, resulting in faster data transfers with minimal protocol overhead. By only using Layer 2, communication remains confined to the local network segment (e.g., within a data center, office building, etc.). This significantly reduces the exposure to external threats compared to Layer 3 and above, where data is routed through multiple public or semi-public networks. Layer 2 communication can use MAC address filtering, ensuring that only authorized devices are permitted to communicate, adding a layer of security against unauthorized access. Layer 2 communication is often more deterministic and reliable within a controlled network, as there is no need to deal with routing issues, packet fragmentation, or congestion problems usually associated with Layer 3 and higher. In dedicated local networks, Layer 2 protocols like Ethernet can support guaranteed bandwidth and quality of service (QoS) mechanisms. This ensures consistent performance when dealing with high-bandwidth AI/ML tasks such as real-time video processing or sensor data analysis.

As such, the second user endpoint 104 requests the AI/ML model (the AI/ML model use request 204) and receives the AI/Ml model without making a direct connection to the AI/ML endpoint 110. As such, all the layers of the OSI model need not be used. Instead, only Layer 2 of the OSI model may be used to complete the transfer of the AI/ML model from the AI/ML endpoint 110 to the second user endpoint 104.

In another example, in active scanning, the first user endpoint 102 performs a broadcast search 210 to locate a particular AI/ML model. The broadcast search 210 is detected by the AI/ML endpoint 110. In active scanning, the first user endpoint 102 initiates communication by making an inquiry or query to prompt communication from nearby AI/ML endpoints. As such, the first user endpoint 102 makes requests or inquiries regarding what AI/ML models the AI/ML endpoint 110 can support and provide.

The AI/ML endpoint 110 sends a beacon request 212 to the first user endpoint 102. The first user endpoint 102 makes a request 214 to use an AI/ML model. The AI/ML endpoint 110 sends an authentication request 216 to the first user endpoint 102. The first user endpoint 102 provides an authentication 218. The AI/ML endpoint 110 returns an authentication token 220 to the first user endpoint 102. When the first user endpoint 102 receives the authentication token 220, the first user endpoint 102 re-submits the AI/ML model request as re-submitted AI/ML model request 222 with the authentication token 220. The AI/ML endpoint 110 receives the re-submitted AI/ML model request 222 with the authentication token 220 and sends the AI/ML model 226 to the first user endpoint 102. Thus, the first user endpoint 102 requests the AI/ML model (the request 214) and receives the AI/Ml model without making a direct connection to the AI/ML endpoint 110. As such, all the layers of the OSI model need not be used. Instead, only Layer 2 of the OSI model may be used to complete the transfer of the AI/ML model from the AI/ML endpoint 110 to the first user endpoint 102.

In one example, performing a model compute may include receiving a request from a user endpoint and providing the requested AI/ML model to the user endpoint. The requested AI/ML model may be selected from pre-generated and pre-stored AI/ML models. The requested AI/ML model may be retrieved from a database of stored AI/ML models. The requested AI/ML model may also be retrieved from outside sources (e.g., AI/ML repositories such as HuggingFace). The requested AI/ML model may be a combination of all of these forming fine-tuned models that fit the specific environment and endpoint user needs. All these complexity may be hidden from the user endpoint. The requested AI/ML model is provided via the Layer 2 of the OSI model. As such, the connection between the user endpoint and the AI/ML endpoint is provided only by the Layer 2 of the OSI model.

In another example, performing a model compute may include generating an AI/ML model based on an inquiry or query. In this form, the specificity of the AI/ML model to be used is unimportant, and it is driven only by the inquiry or query in the form of a prompt. This may include applying mathematical operations that make up the AI/ML model to input data, and generating outputs such as predictions, classifications or recommendations. Thus, the AI/ML model may be generated in response to the type of prompt or inquiry or query made by the user endpoint. The AI/ML model may be generated in response to the type of details in the query submitted by the user endpoint. The generated AI/ML model may be provided from the AI/ML endpoint to the user endpoint via only the Layer 2 of the OSI.

In some examples, the system may use time to live (TTL) tags and information as necessary. For example, authentication into the system may be limited to a particular time frame. A user may be given priority based on TTL tags, or a particular system may decide to keep information of its users based on a TTL mechanism.

In other examples, some requests may be stateful requests and some requests may be stateless requests. A stateless request means that each request from a client to an AI/ML endpoint is treated independently. The AI/ML endpoint does not retain any memory of the previous requests. All the information needed to process the request is provided by the client within the current request itself. A stateful request means that the AI/ML endpoint maintains information about the client's previous interactions (states) across multiple requests. The AI/ML endpoint stores session data and uses it to provide a more coherent experience across requests. In the examples, some models can benefit from a stateful computation of AI/ML models. For example, assistants based on an LLM model often maintain the chat history to continue the conversation. A version of this model can support a stateful session in the AI/ML endpoint 110. This session can exist for a given TTL, or be maintained by the AI/ML endpoint in a local database via a UserID, acting as persistent memory for the model. The UserID can be formed via the device ID MAC address, or any other unique identifier available in the network devices. Allowing for sessions would reduce the traffic between devices by allowing a history of previous requests to be maintained (e.g., the chat history of a session with an agent). Additional data frames may be needed to reset/forget a stateful session, or open a new session.

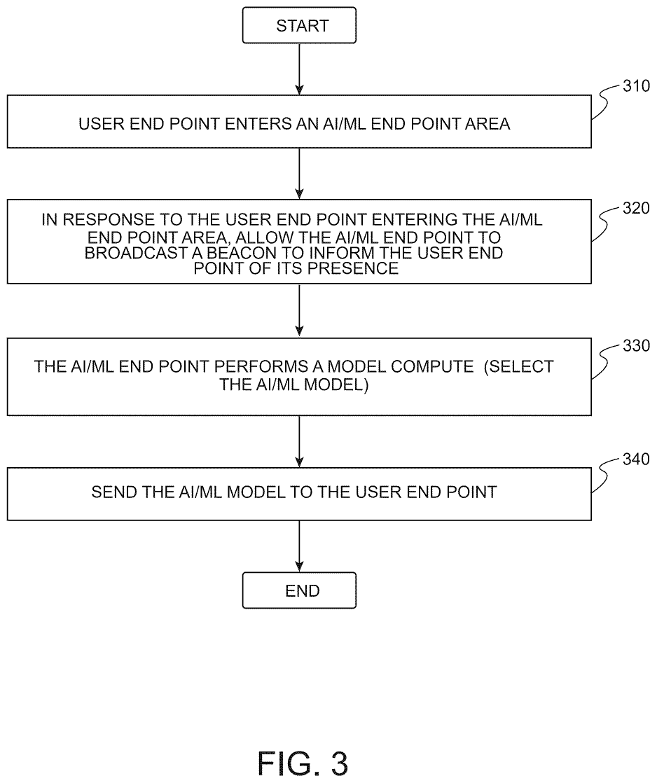

FIG. 3 illustrates a method for transmitting an AI/ML model from an AI/ML endpoint to a user endpoint without authentication, according to an example.

At 310, the user endpoint enters an AI/ML endpoint area. When the user endpoint enters the area of the AI/ML endpoint, it can trigger a dynamic interaction between the user endpoint and the AI/ML model endpoint.

At 320, in response to the user endpoint entering the AI/ML endpoint area, the AI/ML endpoint broadcasts a beacon to inform the user endpoint of its presence.

At 330, the AI/ML endpoint performs a model compute (to retrieve or generate the AI/ML model). In one example, the AI/ML endpoint executes the underlying computations used for producing or generating the AI/ML model. This may include applying mathematical operations that make up the AI/ML model to input data, and generating outputs such as predictions, classifications or recommendations.

At 340, the AI/ML model is sent to the user endpoint. In some embodiments, the weights, inputs, or outputs are broadcast to the user endpoint.

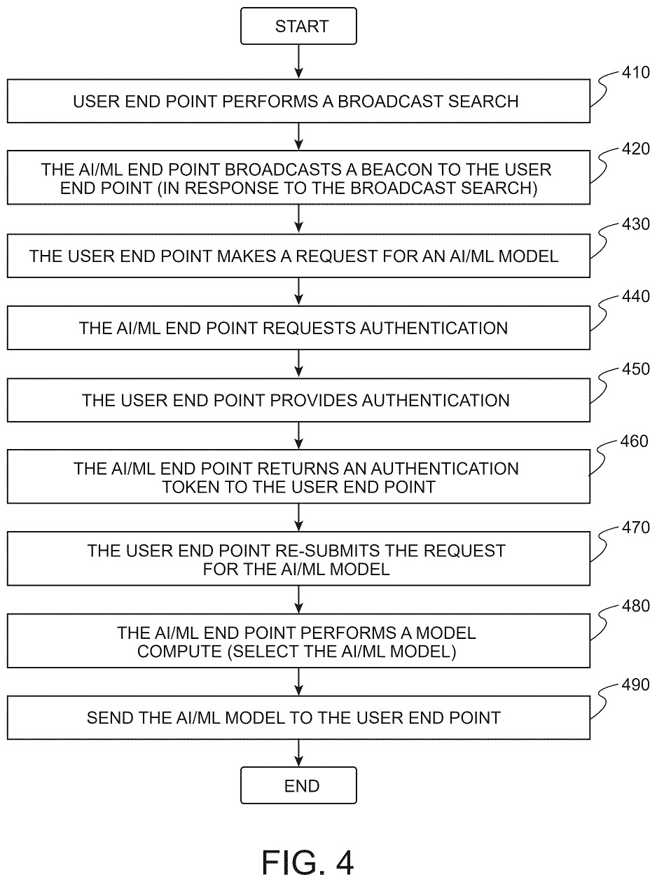

FIG. 4 illustrates a method for transmitting an AI/ML model from an AI/ML endpoint to a user endpoint with authentication, according to an example.

At 410, the user endpoint performs a broadcast search. In other words, the user endpoint sends out a general query or request across the network to discover nearby devices. This search does not target a specific destination but rather broadcasts the query to all available AI/ML model endpoints within the reach of the network.

At 420, the AI/ML endpoint broadcasts a beacon to the user endpoint in response to the broadcast search. The AI/ML endpoint thus signals its presence and availability to provide the AI/ML model. The beacon acts as an announcement that may include information about the AI/ML model.

At 430, the user endpoint makes a request for an AI/ML model.

At 440, the AI/ML endpoint requests authentication. In other words, the AI/ML endpoint requests the user endpoint to provide credentials or verify its identity before allowing access to the AI/Ml model. This ensures that only authorized devices can interact with the AI/ML models.

At 450, the user endpoint provides authentication. The user endpoint, upon receiving the authentication request, sends back a response with the appropriate credentials.

At 460, the AI/ML endpoint returns an authentication token to the user endpoint. Once the user endpoint credentials are received, the AI/ML endpoint verifies the information. If the credentials are correct and valid, the AI/ML endpoint forwards a token to the user endpoint. The token may be a cryptographically signed piece of data, which proves that the user endpoint is now authorized to access the AI/ML models. The token may include user identify, session validity period, access permissions, and a signature to ensure token integrity.

At 470, the user endpoint re-submits the request for the AI/ML model. With the authentication token in hand, the user endpoint resubmits the request to access the AI/ML model. This request now includes the authentication token to prove that the user endpoint has been authorized.

At 480, the AI/ML endpoint performs a model compute (to retrieve or generate the AI/ML model). In one example, the AI/ML endpoint executes the underlying computations used for producing or generating the AI/ML model. This may include applying mathematical operations that make up the AI/ML model to input data, and generating outputs such as predictions, classifications or recommendations.

At 490, the AI/ML model is sent to the user endpoint. In some embodiments, the weights, inputs, or outputs are broadcast to the user endpoint.

In an example, the system and method can be used as a gateway for cloud systems or high-performance computing (HPC) systems. An AI/ML endpoint is continuously connected to a server that exposes powerful computation to several AI/ML models. These AI/ML models can be part of a catalog that is compared against the AI/ML model requests from the user. If available, the AI/ML endpoint can forward the request for computation to the cloud or an HPC server that can provide the result of the given AI/ML model. In this operation mode, the AI/ML endpoint acts as mailman communicating to known servers, removing the burden of the user to establish the connection.

The advantages of the system and method include that availability of AI/ML models can be associated with a local area or specific location, determined by the reach of the physical network. For example, an AI/ML model can be trained with information that is only relevant to a specific area or location. Nearby users or user endpoints that are present in this area or location can benefit from these AI/ML models without the need to establish connections with a priori information between a server and a client. The transparency of the protocol allows the system to access the intelligence of the AI model automatically. For example, an assistant software running on a device may benefit from information that is obtained from these AI/ML models, as they communicate with the nearby devices in a scheme that is transparent to the user.

Another advantage is that devices can offload computations to endpoints in order to exploit better compute capabilities of nearby devices or cloud servers, without the need to have a client/server infrastructure with a known destination. For example, a smartphone with limited compute power may use generative AI models that are available in the nearby Wi-Fi routers, which have a stable power supply and larger form factors that can result in stronger compute power. Currently, it is possible to offload computation, but in order to accomplish that, a connection is established with a known server. Network discovery protocols could work at higher levels of the network stack (e.g., applications that use peer-to-peer (P2P) protocols, or protocols similar to printer discovery mechanisms), but this involves each application to be aware of the connection. Embedded devices with thin software layers can still benefit from lower level protocols. Furthermore, lower energy requirements may be achieved if this protocol is supported by hardware directly.

Another advantage is that the system and method use AI/ML models transparently, without the need for application interventions or ad-hoc solutions. The AI/ML endpoints can be available at different locations and the protocols between user endpoints and AI/ML endpoints have already been proven to work (e.g., Wi-Fi can be take advantage of whenever present near a user endpoint). Furthermore, the AI/ML endpoints can serve as gateways for extended AI/ML users.

In a practical application, a user endpoint may enter a specific location, e.g., a shopping area. In one example, once the user endpoint enters such specific location, the user endpoint can send a request or inquiry regarding an AI/ML model. For example, the user endpoint may prompt or inquire or request an AI/ML model that is specific or tailored to that location, that is, to that specific shopping area. The AI/ML model can leverage a variety of details and data points tailored to enhance the shopping experience. The AI/ML model can integrate contextually relevant information based on the shopping area's offerings, user preferences, and real-time data. The AI/ML model may include, e.g., personalized recommendations, location-based assistance, shopping preferences, behavior prediction, contextual information, such as real-time crowd insights, event notifications, seasonal offerings, product details and reviews loyalty program updates, and membership-exclusive offers. The AI/ML model may be pre-generated and provided to the user endpoint. In another example, once the user endpoint enters such specific location, the AI/ML endpoint can detect the user endpoint and on its own (without being prompted) and send a list of AI/ML models to the user endpoint. The user endpoint can then select which AI/ML model is most relevant to the user endpoint. For example, one of the AI/ML models may include information regarding local cultural preferences. That is, the AI/ML model can cater to cultural preferences of locals or dietary restrictions (e.g., restaurants serving a specific type of cuisine). As such, the user endpoint can access AI/ML models that are location-specific.

In one example, the AI/ML models may be stored on the client device indefinitely and can be accessed by the user at any time, regardless of their location. The benefits of such approach include offline access, that is, the user can access the AI/ML model and its services even when they are not connected to the Internet, enhancing convenience in areas with poor connectivity. Continuous personalization can also be achieved, that is, the AI/ML model can evolve over time, adapting to the user's preferences, habits, and patterns to provide more accurate and personalized suggestions. Reduced latency can be achieved as permanent storage enables faster access to the AI/ML model as it does not include downloading or streaming the AI/ML model in real-time. Further benefits include improved user experience as frequent users benefit from seamless access without needing to reload or reinitialize the model for every session.

In another example, the AI/ML model is stored on the user device temporarily or only while the user is in a specific location, such as a shopping mall, airport, or event space. The benefits of such approach include privacy control, as users can opt to use location-specific models that are deleted once they leave the location, ensuring that sensitive data tied to a specific area is not retained long-term. Resource efficiency, as storing the AI/ML model temporarily minimizes storage usage on the client device, which is beneficial for users with limited storage capacity. Other benefits include location-specific customization, as the AI/ML models can be tailored to a specific environment (e.g., a shopping mall or entertainment venue), providing location-specific offers, services, and recommendations, and reduced data transfer as the AI/ML model only exists on the client device when necessary, reducing the need for large data transfers, especially when bandwidth is a concern.

In yet another example, the AI/ML user endpoint may store information on which users accessed specific AI/ML models. This information can be used to improve the AI/ML models, tailor services, and provide valuable insights. The tracking may include user behavior tracking, that is, the AI/ML endpoint stores details of which AI/ML models have been accessed by the user or client device, including usage frequency, duration, and context (e.g., time, location, specific tasks performed). Tracking may also include model-specific interactions, that is, the AI/ML endpoints tracks interactions with different AI/ML models (e.g., shopping assistant model, navigation model, recommendation engine), recording which models were engaged and for what purpose. The data can include user demographics, usage patterns, and any adjustments made by users to the model's suggestions or services. The benefits of tracking AI/ML model usage may include, e.g., increased user experience, improved AI/ML model performance, usage analytics for business insights, providing enhanced privacy and security, and context-aware service delivery.

In conclusion, the examples present a system and method for broadcasting different AI/ML models, its weights, inputs, or outputs to client devices or user endpoints. The examples establish a mechanism to expose and use AI/ML models from nearby devices (e.g., AI/ML endpoints). The system first creates a low level (layer-2) communication protocol that can be used to expose, optionally authenticate, and use an AI/ML model that is observed in a physical media (e.g., over wireless networks or wired Ethernet-like networks). This is similar to how a Wi-Fi network can be exposed via IEEE 802.11. As such, a user endpoint can establish a connection to the network without having prior information about the existence of the network or the AI/ML endpoints connected to the network.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An artificial intelligence/machine learning (AI/ML) endpoint, comprising:
circuitry configured to communicate with a user endpoint by:
broadcasting a beacon;
receiving an AI/ML model request from the user endpoint;
performing a compute operation to select an AI/ML model; and
transmitting the AI/ML model to the user endpoint.

2. The AI/ML endpoint of claim 1, wherein the beacon is broadcast when the user endpoint enters an AI/ML endpoint area.

3. The AI/ML endpoint of claim 1, wherein the AI/ML endpoint creates a low level communication protocol to communicate with the user endpoint.

4. The AI/ML endpoint of claim 3, wherein the low level communication protocol is included in Layer 2 of an open systems interconnection (OSI) model.

5. The AI/ML endpoint of claim 4, wherein the user endpoint uses the AI/ML model without executing all layers of the OSI model.

6. The AI/ML endpoint of claim 1, wherein the AI/ML endpoint makes an authentication request to the user endpoint.

7. The AI/ML endpoint of claim 6, wherein the user endpoint provides authentication to the AI/ML endpoint that returns an authentication token to the user endpoint.

8. The AI/ML endpoint of claim 7, wherein the user endpoint resubmits the AI/ML model request with the authentication token to the AI/ML endpoint to receive the AI/ML model.

9. The AI/ML endpoint of claim 1, wherein the compute operation comprises retrieving the AI/ML model from a database including pre-generated AI/ML models.

10. The AI/ML endpoint of claim 1, wherein the compute operation comprises generating the AI/ML model based on information submitted in the AI/ML model request from the user endpoint.

11. A method comprising:
broadcasting a beacon from an artificial intelligence/machine learning (AI/ML) endpoint;
sending, by a user endpoint, an AI/ML model request to the AI/ML endpoint upon detection of the beacon;
performing, by the AI/ML endpoint, a compute operation to select an AI/ML model; and
transmitting the AI/ML model to the user endpoint.

12. The method of claim 11, wherein the AI/ML endpoint creates a low level communication protocol to communicate with the user endpoint.

13. The method of claim 12, wherein the low level communication protocol is included in Layer 2 of an open systems interconnection (OSI) model.

14. The method of claim 13, wherein the user endpoint uses the AI/ML model without executing all layers of the OSI model.

15. The method of claim 11, wherein the compute operation comprises retrieving the AI/ML model from a database including pre-generated AI/ML models or generating the AI/ML model based on information submitted in the AI/ML model request from the user endpoint.

16. The method of claim 11,
wherein the AI/ML endpoint makes an authentication request to the user endpoint,
wherein the user endpoint provides authentication to the AI/ML endpoint that returns an authentication token to the user endpoint, and
wherein the user endpoint resubmits the AI/ML model request with the authentication token to the AI/ML endpoint to receive the AI/ML model.

17. An artificial intelligence/machine learning (AI/ML) endpoint, comprising:
circuitry configured to receive an AI/ML model request from a user endpoint sending a beacon broadcast, the AI/ML endpoint configured to:
request authentication from the user endpoint;
receive authentication information from the user endpoint;
send an authentication token to the user endpoint;
receive a resubmission of the AI/ML model request and the authentication token from the user endpoint;
perform a compute operation to select the AI/ML model; and
transmit the AI/ML model to the user endpoint.

18. The AI/ML endpoint of claim 17, wherein the AI/ML endpoint creates a low level communication protocol to communicate with the user endpoint.

19. The AI/ML endpoint of claim 18, wherein the low level communication protocol is included in Layer 2 of an open systems interconnection (OSI) model.

20. The AI/ML endpoint of claim 17, wherein the compute operation comprises retrieving the AI/ML model from a database including pre-generated AI/ML models or generating the AI/ML model based on information submitted in the AI/ML model request from the user endpoint.
